(19) United States
(12) Patent Application Publication
(10) Pub. No.: US 2012/0171330 A1
(43) Pub. Date: Jul. 5, 2012

(54) CURED CHUNKY MEAT PRODUCT, IN PARTICULAR BOILED HAM

(75) Inventors: Nicolas Böge, Hamburg (DE); Jens Urbat, Hamburg (DE)

(73) Assignee: ZYLUM BETEILIGUNGSGESELLSCHSFT mbH & Co. PATENTE II KG, Schonefeid/Waltersdorf (DE)

(21) Appl. No.: 13/395,250

(22) PCT Filed: Sep. 10, 2010
(86) PCT No.: PCT/EP2010/063282

§ 371 Date: Mar. 9, 2012

(30) Foreign Application Priority Data
Sep. 11, 2009 (DE) 20 2009 012 378.2

(51) Int. Cl. A23L 1/314; A23L 1/302

(52) U.S. Cl. 426/72

(57) ABSTRACT

A cured chunky meat product, in particular boiled ham, is provided which contains a higher content of folic acid substances selected from folic acid, salts of folic acid and derivatives of folic acid or folic acid salts, compared to the natural content of these substances in the meat. In particular, the meat product contains folic acid substances in an amount of between 3 mg/kg and 20 mg/kg of the meat product.

### CROSS-REFERENCE TO RELATED APPLICATIONS

This application is a Section 371 of International Application No. PCT/EP2010/063282, filed Sep. 10, 2010, which was published in the German language on Mar. 17, 2011, under International Publication No. WO 2011/029893 A1 and the disclosure of which is incorporated herein by reference.

### BACKGROUND OF THE INVENTION

The present invention relates to a cured chunky meat product, in particular boiled ham.

Meat products in cooked preserved form, particularly cured, are playing an increasingly significant role in the nutritional culture of many industrialized nations. Such meat products range from conventional sausage products to long-term preserved party and snack meat products, which are also becoming increasingly popular as between-meal items. Yet such dietary habits come at the expense of ingesting such plant-based nutritional products as, for example, fruits and vegetables, which are also predominantly responsible for supplying the human body with sufficient amounts of vitamins and other physiologically important nutrients, secondary phytonutrients and fiber.

This important public health-related circumstance leads to the necessity of seeking out new nutritional means which, on the one hand, enable the popular consumption of meat products and, on the other hand, afford a balanced diet and prevent deficiencies.

An initial approach in this regard was proposed by German published patent application DE 100 47 515 A1, which describes a method for manufacturing a meat product, wherein the meat product is tumbled with a vitamin mixture dissolved in a liquid. During the tumbling process, the meat product is massaged while being simultaneously kept in contact with the liquid in which the vitamin mixture is dissolved. This liquid into which the vitamin mixture was introduced prior to the tumbling process is preferably water. The meat product partly or even fully absorbs the liquid when being tumbled, such that by the end of the tumbling process, the meat product has been vitaminized. The vitamin mixture here contains vitamins B1, B6, B12 and C, for example. The vitamin mixture can additionally also contain vitamin E as well as niacin, pantothenic acid and biotin.

Disadvantageous with the method described in DE 100 47 515 A1, however, is that the vitamin mixture is not only not conducive to preserving the meat product, but can also sometimes impair the quality of the finished product to a not insignificant degree, since even detrimental albeit naturally occurring microorganisms are introduced into the meat product during tumbling. Accordingly, numerous meat products vitaminized in accordance with the described method can exhibit lower product quality.

### BRIEF SUMMARY OF THE INVENTION

Proceeding from this prior art, there is the need to provide a processed meat product which does not exhibit the above described disadvantages. Consequently, the present invention is based on the object of providing a meat product of guaranteed good product quality on the one hand and, on the other hand, one which has greater additional health-promoting qualities compared to conventional meat products.

This object is achieved by a cured chunky meat product, in particular boiled ham, which is characterized in that, compared to a natural content of folic acid, a salt of folic acid and/or a derivative of these substances, the meat product has a higher content of these substances, in particular between 3 mg/kg to 20 mg/kg of meat product.

Numerous studies have proven the many healthy aspects to folic acid, also known as vitamin B9. The salts of folic acid, folic acid derivatives respectively, which will be referred to by the general term of folic acid in the following, also show comparable health-promoting qualities. Folic acid not only constitutes an extremely important and essential factor in terms of the body's cellular-biological processes, as for example during cell division and cell regeneration, it also has proven protective effects on the functioning of the human cardiovascular system. Folic acid also guards against arteriosclerotic deposits in the human vascular system. Furthermore, clear results were seen in medical studies pointing to a correlation between neural tube defects in babies and lower folic acid intake by the mother during the first six weeks of pregnancy.

Not even considering the heath aspects folic acid contributes with food intake, applicant has been additionally able to prove that folic acid also positively impacts the aging process of fermented meat products, in particular cured chunky meat products, to a significant degree. Increased firmness and improved color-fastness to the meat product have hereby been proven as positive technological effects.

The fundamental inventive concept is thus based on improved quality to the preserved meat product as well as the beneficial supplying of folic acid when consumed, the latter involving proven health-promoting aspects for the consumer.

According to one particularly preferred embodiment, the cured chunky meat product is furthermore fortified with folic acid.

According to a further embodiment of the cured chunky meat product, the folic acid, a salt of folic acid and/or a derivative of these substances is dissolved in a curing brine, which is provided for the purpose of preserving the meat product and which is introduced into the meat during the curing process. The folic acid, a salt of folic acid and/or a derivative of these substances can hereby be added to the curing brine as a single substance or a substance mixture. These substances are preferably pre-dissolved prior to producing the finished curing brine as a whole and are then added to the curing brine already in a dissolved state. Doing so thus enables monitoring and ensuring the complete and rapid dissolution of these substances, whereby the quantitative volume of the substances in the curing brine can also be precisely calculated for effective preserving.

In a further development, the curing method incorporates an injection pursuant to a brine injection process, in particular pursuant to the vein injection process or the muscle injection process, to preserve the cured chunky meat product. To control the amount injected, the cured chunky meat product is typically weighed before and after the injection. The vein injection process, in which the curing brine is injected into the naturally occurring vessels, ensures a fast and even distribution of the curing brine through to the bones, which can be surrounded by the meat product. This thereby achieves improved preserving of the microbiologically vulnerable marrow and periosteum. The muscle injection process is performed using cannulae and is technically simpler compared to the vein injection process. Yet care must be taken in the muscle injection process to introduce the plurality of cannulae into the meat product at an even geometrical distribution, so as not to inject individual areas of the meat product with too much curing brine. The injection depth also needs to be technically monitored in the muscle injection process.

In a further embodiment, subsequent to the injection process, the meat product is further wet-cured in a curing brine having, for example, the same strength as the injected curing brine in order to continue the curing process further.

In a further development, the weight ratio of injected curing brine to meat product amounts to between 5% and 20%, in particular between 7% and 10%. This, on the one hand, thus ensures that sufficient amounts of folic acid will be introduced into the meat product to realize the proven health-promoting effects for the consumer while, on the other hand, it appreciably improves the preservation of the meat product by curing.

According to an embodiment, it can also be further provided for the curing brine to comprise further micronutrients, soluble fiber and/or natural extracts. Such natural extracts can be of animal or vegetal origin and are particularly associated with health-promoting qualities. Applicable vegetable extracts can, for example, be extracts from the aloe vera plant. Noted here is that all reasonable food-grade substances, which also promote health, are applicable as further micronutrients or soluble fiber.

In one preferred embodiment, the cured chunky meat product is heated, in particular boiled. This hereby particularly refers to the cured chunky meat product also being boiled ham. The heating or boiling step typically occurring subsequent to the curing process contributes to the further and improved preserving of the meat product.

It is moreover also conceivable to smoke the cured chunky meat product. The smoked meat product hereby exhibits even further improved preserved qualities in comparison to a meat product preserved solely by the curing process. In addition, the meat product is given further flavors which can enhance a consumer's consumption.

In a further embodiment, the cured chunky meat product is tumbled. Pumping can also replace tumbling which, like tumbling, achieves a mechanical processing of the meat product, which contributes to the better distribution of the curing brine and the substances in the curing brine into the meat product. The meat product is hereby mechanically massaged in specially designed drums or agitating devices which loosens the musculature, on the one hand, and enables the curing brine to better penetrate into the musculature, on the other hand. As a result, the distribution of the curing brine in the musculature is accelerated. Tumbling can also destroy the connective tissue of the muscle fibers to some extent, such that increased muscle protein can end up in the brine or tumbling solution. Tumbling, like pumping, should hereby occur at controlled cool temperatures between 4° C. and 8° C. The tumbling time varies as a function of the equipment used and its run speed. In vacuum tumbling, a vacuum of 0.8 bar is preferred.

According to a further preferred embodiment of the cured chunky meat product, in addition to folic acid, folic acid salt and/or a derivative of these substances, the curing brine contains nitrite brine as well as further conceivable brine additives, such as ascorbate, sugar, glutamate, phosphate, lactate, and/or spices, in each case at 1.0 kg to 1.8 kg per 10 kg water or per 10 kg ice/water mixture. The ice/water mixture can hereby be at 8 kg water and 2 kg ice in the winter season, whereby just 7 kg water and 3 kg ice would make sense in the summer season.

According to a preferred further embodiment of the cured chunky meat product, the meat product exhibits a 1.5% to 2.5% concentration of common salt, particularly 1.7% to 2.1%. This thereby provides good preservation on the one hand while, on the other hand, providing a taste to the meat product which best suits the human sense of taste.

### DETAILED DESCRIPTION OF THE INVENTION

The following will collectively present a few further aspects in respect of further embodiments of the invention, further embodiments of the inventive curing method, respectively.

The pieces of meat used to prepare the cured chunky meat product can be prime cuts of the haunch as with hind hams, respectively shoulder cuts as with ham shoulders, from pork as well as from beef or calf. These meat products are not usually incorporated into sausage meat unless serving to bind larger pieces of meat, such as in the case of Kaiserfleisch (smoked pork belly), for example.

Apart from the qualities which the added folic acid, folic acid salt and/or derivative of these substances have with respect to the quality of the preserved meat product, the preservation quality is determined by the addition of salt, nitrite, sugar, and other curing additives. Further preserving effects are obtained by heating and/or boiling and/or smoking the meat product. Preservation is thereby to achieve an even, deep and long-lasting cured color. The meat product should be firm and juicy, although not watery, wherein it should not fall apart even when slices are cut from it.

In the preserving process as described, the quality of the final product is also influenced by the selection of the raw material, which requires aging prior to curing, particularly when producing boiled ham. For example, in producing pork boiled ham, the topside and the silverside of the slaughtered pig need to be aged for at least three days in cold storage at a temperature of from 3° C. to 4° C. For the further processing, dark pieces of the meat are particularly preferred. These are characterized in particular by their favorable properties with respect to water retention, receptivity to curing, their shelf life and taste. Pieces of meat intended for preserving further have a pH of 5.6 to 6.0. Preparing a meat product for preservation typically entails trimming the raw material as well as stripping away the interior fatty tissue (gristle) and sinews.

When producing the curing brine for preserving the meat product, all the ingredients are stirred into the water and dissolved and thereafter mixed with additional added ice. Alternatively, individual ingredients of the curing brine can also be pre-dissolved in order to ensure full and/or controlled dissolution. After production, the temperature of the curing brine should be at 6° C. to 8° C.

The volume of the curing brine, i.e., the ratio of water or ice to the added ingredients, as well as the ratio of the curing brine to the meat, typically constitutes the most important influencing factor as far as largely determining the salt concentration in the final product. In performing brine injection, the curing brine is injected into the chunky meat product to be cured immediately after mixing. The brine injection, as also the conceivable subsequent curing in a curing brine, ensures sufficient infusing, i.e., sufficient penetrating of the curing brine into the meat product to be preserved. As a result of the curing, the meat's characteristics are changed due to physical, chemical and also microbiological processes.

The following will describe various different production processes employed in three different curing methods for preserving a chunky meat product to be cured. The three curing methods depicted primarily relate to the penetrating of the curing brine into the meat product when producing boiled ham.

### Example 1

The first curing method utilizes a brine volume of from 7% to 14%. A brine injection process hereby injects the brine either twice at 10% by weight in relation to the weight of the meat to be cured or three times at 7% by weight in relation to the weight of the meat to be cured. After each injection and/or after the total number of injection procedures, the meat product is tumbled for an interval of time. During the first day, the meat product is tumbled for intervals of 15 minutes with a 15-minute pause between each interval for a total of 8 to 12 hours. On the second day of producing the meat, the tumbling is resumed at 20 to 30 minute continuous intervals.

### Example 2

The second production method likewise utilizes a brine volume of from 7% by weight in relation to the weight of the meat to be cured to 14% by weight in relation to the weight of the meat to be cured, whereby brine is injected into the meat product in each case either twice at 10% or three times at 7% volume. After each injection and/or after the total number of injection procedures, the tumbling is continuous, wherein the machine runs in this case continuously for 1.5 to 2.5 hours. For purposes of further distributing the brine into the meat product, the meat product is left in the tumbling machine overnight. A further run through the tumbling machine occurs on the second day, wherein the run lasts 1 to 2 hours.

### Example 3

In accordance with the third production method, the chunky meat product to be cured is tumbled in a curing brine at 7% to 8% brine volume immersion. In the context of the curing process, the brine injection additionally encompasses a two-stage processing with 10% brine, or a three-stage processing with 7% brine. Compared to the previous curing method, however, there is no tumbling; instead, the meat product is immersed subsequent the injection, such that it is fully covered by the curing brine. The meat product is subsequently kept in cold storage for 10 to 12 hours at 3° C. to 4° C. On the second day, the immersed meat product is dried and then routed to further processing, for instance by heating or boiling.

For the subsequent processing, the meat products which have been processed in one of the above depicted curing methods are either inserted and pressed into suitable molds or filled into suitable casings, for example of 140 to 160 caliber. The meat products are thereafter boiled at a temperature of approximately 70° C. After boiling, the meat products are cooled for 2 to 3 hours at approximately room temperature and thereafter stored for 12 to 14 hours in cold storage.

The advantage of tumbling the meat product lies in that cuts of meat made to act as binders are easily joined together into pressed or formed meat products. To this end, the meat products are typically packed or fed into steam-permeable casings or pouches and held together in the subsequent heating process by the coagulating of the dissolved proteins.

The transglutaminase enzyme, which is also industrially produced, is moreover frequently added to the curing brine to be injected to enable better binding and increase the slicing firmness, whereby a further releasing of muscle protein ensues, which effects an additional firming of the cured goods by coagulation of the released proteins in the subsequent boiling process. The resulting binding ensuing from this particular processing is clearly much stronger.

In accordance with a further type of processing of the cured chunky meat product, the same can also be smoked when the meat product is fed into steam/smoke-permeable casings. Smoking not only achieves the forming of a visually appealing smoked appearance and flavoring, but it also intensifies the meat product's reddening. Hot smoking is moreover possible when producing boiled ham, effected as a function of the applied temperature control (65° C. to 85° C., relative humidity>50%) over a period of from 20 to 45 minutes. After being heated, the cured chunky meat product is rapidly cooled in order to also inhibit the growth of surviving microorganisms. The subsequent storage temperature should not exceed 5° C.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1-10. (canceled)

11. A cured chunky meat product, wherein the meat product has a higher content of folic acid substances selected from folic acid, salts of folic acid and derivatives of folic acid or salts of folic acid, compared to a natural content the folic acid substances.

12. The cured chunky meat product according to claim 11, wherein the meat product has a higher content of the folic acid substances in a range of 3 mg/kg to 20 mg/kg of the meat product.

13. The cured chunky meat product according to claim 11, wherein the folic acid substances are added to the meat product during its production by dissolving in a curing brine for preserving the meat product and introduced into the meat product during a curing process.

14. The cured chunky meat product according to claim 13, wherein the folic substance-containing curing brine is introduced by a brine injection process selected from a vein injection process and a muscle injection process.

15. The cured chunky meat product according to claim 14, wherein a weight ratio of injected curing brine to meat product amounts to between 5% and 20%.

16. The cured chunky meat product according to claim 13, wherein the curing brine comprises further micronutrients, soluble fiber and/or natural extracts.

17. The cured chunky meat product according to claim 11, wherein the meat product is heated.

18. The cured chunky meat product according to claim 11, wherein the meat product is boiled.

19. The cured chunky meat product according to claim 11, wherein the meat product is hot-smoked.

20. The cured chunky meat product according to claim 11, wherein the meat product is tumbled.

21. The cured chunky meat product according to claim 15, wherein, in addition to the folic acid substances, the curing brine contains nitrite brine and at least one further brine additive selected from ascorbate, sugar, glutamate, phosphate, lactate and spices, the brine additive being present in an amount of 1.0 kg to 1.8 kg per 10 kg water or ice/water mixture.

22. The cured chunky meat product according to claim 11, wherein the meat product exhibits a 1.5% to 2.5% concentration of common salt.

23. The cured chunky meat product according to claim 11, wherein the meat product exhibits a 1.7% to 2.1% concentration of common salt.

24. The cured chunky meat product according to claim 11, wherein the meat product is boiled ham.
